(19) United States
(12) Patent Application Publication
(10) Pub. No.: US 2005/0163107 A1
(43) Pub. Date: Jul. 28, 2005

(54) Packet processing pipeline

(76) Inventors: Ravi P. Gunturi, Fremont (CA); Erik J. Johnson, Portland, OR (US); Chen Young Seow, Penang (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/766,282

(22) Filed: Jan. 27, 2004

(51) Int. Cl. H04L 12/66

(52) U.S. Cl. 370/352; 370/412

(57) ABSTRACT

In general, in one aspect, the disclosure describes a method that includes registering a procedure associated with an event, in response to an instruction included in source code for an upstream component, at a downstream component in a packet processing pipeline. The method also includes processing a received packet at the upstream component executing on a first engine, and processing the packet at the downstream component executing on a second engine after the processing of the received packet at the upstream component. The processing at the downstream component includes determining occurrence of the at least one associated event at the downstream component, and in response, executing the registered procedure at the second engine.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The. packet's “payload” is analogous to the letter inside the envelope. The packet's “header” is much like the information written on the envelope itself. The header can include information to help network devices handle the packet appropriately. For example, the header can include an address that identifies the packet's destination.

A given packet may “hop” across many different intermediate network devices (e.g., “routers”, “bridges”, and “switches”) before reaching its destination. These intermediate devices often perform a variety of packet processing operations. For example, intermediate devices often perform operations to determine how to forward a packet further toward its destination or determine a quality of service to use in handling the packet.

A wide variety of architectures have been developed to process packets. For example, an architecture known as a packet processing “pipeline” includes a sequence of packet processing software components that process a packet in turn. For example, a very simple pipeline may include a forwarding component that determines the next hop for a packet and a transmission component that then handles the details of sending the packet out to the network.

The pipeline approach can ease software development by insulating components from one another. For example, rewriting the software of one component to provide some new feature is less like to necessitate a rewrite of other components in the pipeline. Additionally, a programmer rewriting the software for one component may not need to be familiar with the implementation details of the other pipeline components.

### BRIEF DESCRIPTION OF THE DRAWINGS

FIG. 1 is a diagram illustrating a packet processing pipeline.

FIG. 2 is a diagram illustrating upstream communication.

FIGS. 3A-3B are diagrams illustrating registration of a procedure with a downstream component.

FIG. 4 is a flow-chart illustrating registration of a procedure with a downstream component.

FIG. 5 is a diagram of a network processor.

FIG. 6 is a diagram of a network forwarding device.

### DETAILED DESCRIPTION

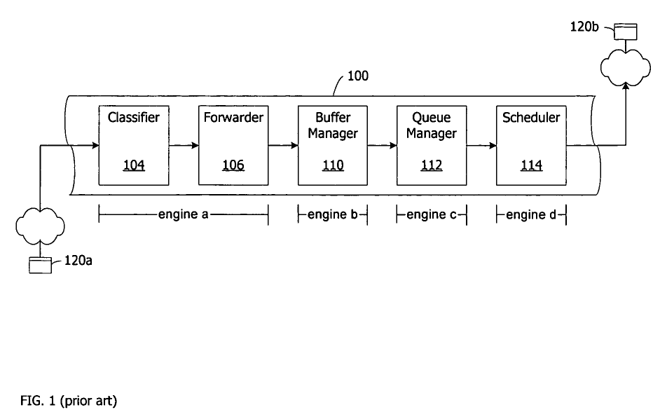

As described above, packet processing operations can be implemented as a pipeline of software components. For example, FIG. 1 depicts a sample packet processing pipeline 100 that forwards received packets. As shown, the sample pipeline 100 includes a sequence of components 104-114 that operate on a packet, in turn, from its receipt until its transmission.

Briefly, in this simplified sample pipeline 100, processing of a packet 120a begins with a classifier 104 that classifies the packet 120, for example, based on its header values. Next, a forwarder 106 determines the packet's 120 next hop, for example, by consulting a routing table. A buffer manager 110 then determines whether to drop the packet 120, for example, based on the system's current capacity to buffer packets. Assuming the packet is not dropped, a queue manager 112 adds the packet to a queue behind previously received packets. Eventually, a scheduler 114 dequeues the packet for transmission.

As shown, the pipeline 100 performs a wide variety of operations to process the packet. Potentially, a single processor may not feature sufficient resources to perform these operations fast enough to keep up with the volume of packets that arrive over a high-speed connection. To speed throughput, some devices, such as a network processor, feature multiple programmable engines that operate simultaneously. For example, in FIG. 1 a multi-engine device has been programmed such that one engine, “a”, executes instructions for the classifier 104 and forwarder 106 components, while engines “b”, “c”, and “d” execute instructions for the buffer manager 110, queue manager 112, and scheduler 114, respectively. In this scheme, while the buffer manager 110 is working on one packet, the queue manager 112 works on another packet that previously entered the pipeline.

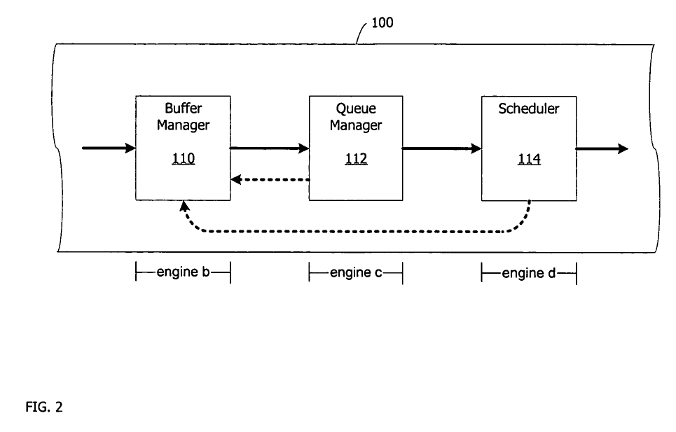

The components of packet processing pipelines can vary considerably between different packet processing applications. However, while the components may vary, the pipeline 100 shown in FIG. 1 nevertheless illustrates the unidirectional, downstream nature of communication among components 104-114 in the sample pipeline 100. Some applications, however, may benefit from upstream communication between components. As an example FIG. 2, depicts a portion of a pipeline 100 where downstream pipeline 100 components 112, 114 “go against the grain” and feed information back to an upstream component 110. For instance, as shown, the queue manager 112 may notify the buffer manager 110 when the queuing of a packet traveling down the pipeline 100 occupies the last available entry in a queue. Similarly, the scheduler 114 may notify the buffer manager 110 when dequeuing a packet creates room in a previously full queue. In response to these events, the buffer manager 112 may drop packets destined for a full queue until receiving notification from the scheduler 114 that the queue again has room. Again, the upstream communication illustrated in FIG. 2 is merely an example. The events of interest and the responses will differ between these and other components.

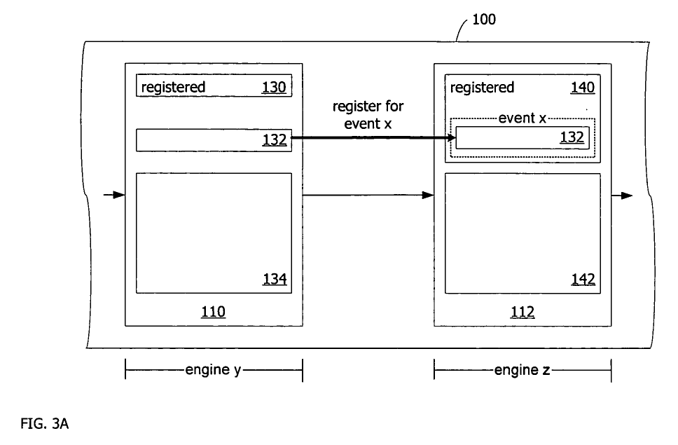

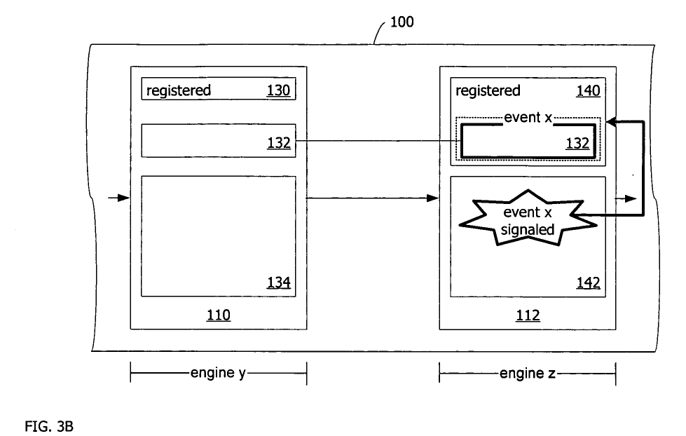

FIGS. 3A to 3B illustrate operation of a scheme to provide an upstream feedback channel for downstream components. The scheme enables an upstream component 110 to register a procedure with the downstream component 112 to be invoked upon detection of some event by the downstream component 112.

In the sample scheme shown in FIG. 3A, upstream component 110 operates on engine “y” while downstream component 112 operates on engine “z”. As shown, the upstream component 110 registers a procedure 132 with downstream component 112 for invocation upon detection of some event “x”. For example, the source code of upstream component 110 may include an instruction of:

register (component_112, procedure_132, event_x);

that indicates that procedure 132 should be invoked when the downstream component 112 detects event “x” (e.g., a full queue). As shown, the instructions of the procedure 132 will be loaded into the engine, “z”, executing the downstream component 112. The registered procedure 132 can include instructions that access data and/or data structures (e.g., variables or structures declared as “private”) defined by the source code for the upstream component 110 even though the procedure 132 may be executed on a different engine than the rest of the component 110.

The registering may occur during run-time. For instance, upstream component 110 may send a registering message to component 112. Alternately, the registering may occur during compile time. For example, a compiler may encounter a “register” instruction in the code of the upstream component 110 and generate code for the downstream component reflecting the registering. For instance, the compiler may insert event handling code into the downstream component and insert the instructions of the registered procedure 132 into the instructions to be executed on the engine that will execute the downstream component 112 instructions.

As shown in 3B, upon detection of an event, an event handler 140 of the downstream component 112 identifies registered procedures associated with the event. For example, the source code of the downstream component 112 may include an instruction of:

if (QueueEntries>MaximumEntries) event_handler (event_x);

that invokes the event handler 140 of the downstream component 112. The event handler 140 then invokes the registered procedure 132 for execution by engine “z”. The event handler 140 may also invoke other procedures (not shown) registered for this event.

The data structures and locations of data accessed by the registered procedure 132 may be unknown to the downstream component 112 as coded. For example, the upstream component may declare a portion of RAM for a data element named “queue_full”. The original source code for the downstream component may not include this definition, however, the registered procedure may nevertheless include an instruction accessing the upstream component's “queue_full” variable.

The implementation described above is merely an example and a wide variety of variations are possible. For example, in an alternate implementation (not shown), instead of a generic event handler 140 that matches events against event/procedure pairs, the source code of the downstream component 112 may include different “hooks” situated at different execution points. For example, the downstream component 112 may include source code of:

event=enqueue(packet);

post_enqueue(event);

where the enqueue(packet) routine returns an event value (e.g., QUEUE_FULL) and the post_enqueue routine bundles registered procedures to be invoked following the queuing of a packet. In this alternate implementation, the upstream component 110 may register procedures by an instruction that identifies a hook of interest, such as:

register (component_112, pre_enqueue, procedure_132, event_x).

Again, the implementations described above and other implementations may feature instructions having different keywords and/or parameters. Additionally, these instructions may be found at different levels of code (e.g., assembly, high-level source code, and so forth).

In these and other implementations, the scheme illustrated in FIGS. 3A-3B insulates the programmer of the downstream component 112 from the operational details of the upstream component 110. That is, an engineer programming the downstream component 112 need only code signaling of certain events. The programmer of the upstream component 110 can code the registered procedure to manipulate the data structures defined by the upstream component 110 without providing these details to the programmer of the downstream component 112. The techniques described above can also permit integration of upstream communication into existing pipelines with minimal alterations. Thus, additional features can be added to an existing pipeline without substantial development costs.

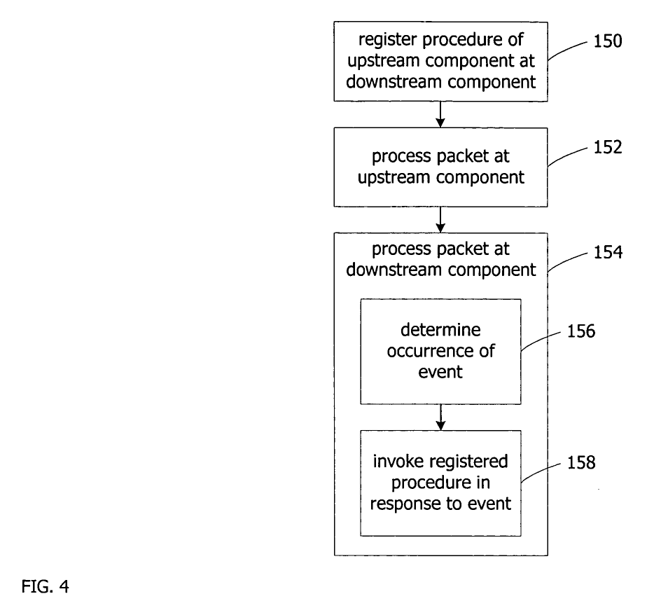

FIG. 4 illustrates operation of a pipeline implementing the scheme described above. As shown, an upstream component registers 150 a procedure with a downstream component for execution in response to the detection of some event. The downstream component may be adjacent to the upstream component or further downstream.

Eventually, after processing 152 of a received packet by the upstream component, the downstream component begins processing of the packet. As shown, this processing can include detection 156 of an event and invocation 158 of the registered procedure at the downstream component's engine in response.

A software pipeline using the techniques described above may be implemented in a variety of hardware environments. For example, the pipeline may be implemented on a multi-processor device such as a network processor.

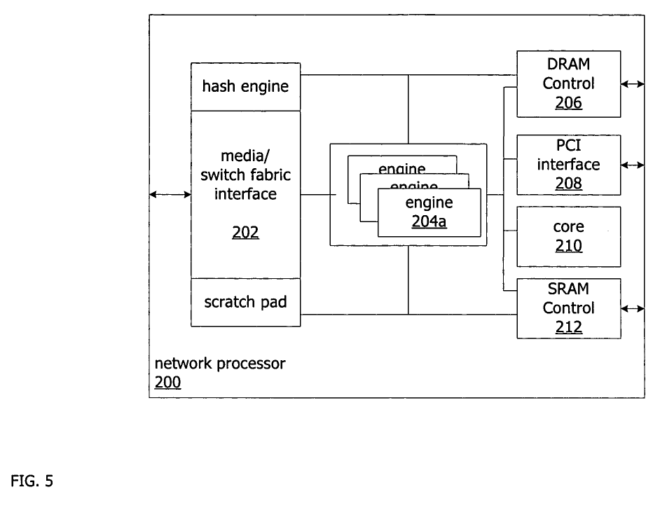

For instance, FIG. 5 depicts an example of network processor 200. The network processor 200 shown is an Intel(r) Internet eXchange network Processor (IXP). Other network processors feature different designs.

The network processor 200 shown features a collection of processing engines 204 on a single integrated semiconductor die. Each engine 204 may be a Reduced Instruction Set Computing (RISC) processor tailored for packet processing. For example, the engines 204 may not provide floating point or integer division instructions commonly provided by the instruction sets of general purpose processors. Individual engines 204 may provide multiple threads of execution. For example, an engine 204 may store multiple program counters and other context data for different threads.

As shown, the network processor 200 also features at least one interface 202 that can carry packets between the processor 200 and other network components. For example, the processor 200 can feature a switch fabric interface 202 (e.g., a Common Switch Interface (CSIX)) that enables the processor 200 to transmit a packet to other processor(s) or circuitry connected to the fabric. The processor 200 can also feature an interface 202 (e.g., a System Packet Interface (SPI) interface) that enables the processor 200 to communicate with physical layer (PHY) and/or link layer devices (e.g., MAC or framer devices). The processor 200 also includes an interface 208 (e.g., a Peripheral Component Interconnect (PCI) bus interface) for communicating, for example, with a host or other network processors.

As shown, the processor 200 also includes other components shared by the engines 102 such as a hash engine, internal scratchpad memory shared by the engines, and memory controllers 206, 212 that provide access to external memory shared by the engines. The network processor 200 also includes a “core” processor 210 (e.g., a StrongARM(r) XScale(r)) that is often programmed to perform “control plane” tasks involved in network operations. The core processor 210, however, may also handle “data plane” tasks.

The engines 204 may communicate with other engines 204 via the core or other shared resources. The engines 204 may also intercommunicate via neighbor registers directly wired to adjacent engine(s) 204.

A packet processing pipeline may be implemented on the network processor in a variety of ways. For example, as described above, different components may execute on different ones of the engines 204. For instance, all N-threads of one engine may execute code of one component and its registered procedures. Alternately, the threads may be divided among components. Different components executing on different engines may communicate using the inter-engine communication techniques described above (e.g., shared memory, next-neighbor registers, and so forth).

The IXP described above features a development environment that supports a programming paradigm featuring pipeline components known as “microblocks”. A microblock is a procedure (e.g., an assembly macro or C function(s)) to be executed by an engine. Potentially, multiple microblocks may be aggregated into a “microblock group” for execution by an engine. The blocks within the group are invoked by a dispatch loop that uses values returned by individual microblocks to identify the next microblock to handle a packet. The packet may be passed to a different engine for processing by another microblock group. In this programming paradigm, the registered procedures may be microblocks inserted into a microblock group associated with a different engine.

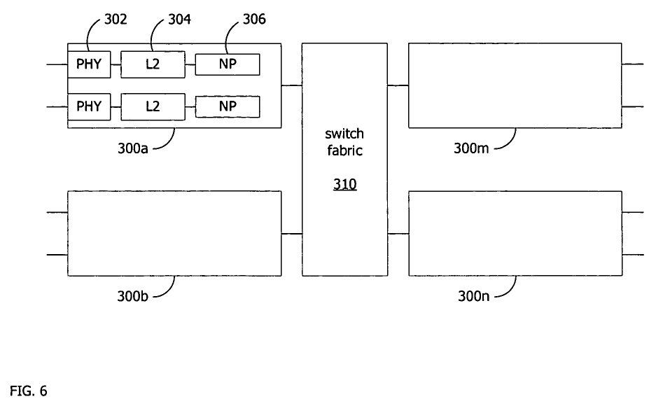

FIG. 6 depicts a network device that can process packets using a pipeline incorporating techniques described above. As shown, the device features a collection of line cards 300 (“blades”) interconnected by a switch fabric 310 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 300a) may include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer devices (e.g., Ethernet, Synchronous Optic Network (SONET), High-Level Data Link (HDLC) framers or other “layer 2” devices) 304 that can perform operations on frames such as error detection and/or correction. The line cards 300 shown may also include one or more network processors 306 that perform packet processing operations for packets received via the PHY(s) 302 and direct the packets, via the switch fabric 310, to a line card providing an egress interface to forward the packet. Potentially, the network processor(s) 306 may perform “layer 2” duties instead of the framer devices 304.

While FIGS. 5 and 6 described specific examples of a network processor and a device incorporating network processors, the techniques may be implemented in a variety of hardware, firmware, and/or software architectures including network processors and network devices having designs other than those shown. Additionally, the techniques may be used in a wide variety of network devices (e.g., a router, switch, bridge, hub, traffic generator, and so forth).

The term packet was frequently used above in a manner consistent with handling of an Internet Protocol (IP) packet. However, the term packet can also refer to a Transmission Control Protocol (TCP) segment, fragment, Asynchronous Transfer Mode (ATM) cell, and other protocol data units depending on the network technology being used. Similarly, pipelines may differ based on the network technology (e.g., IPv4, IPv6, and ATM) and features (e.g., Quality of Service (QoS)) being provided.

As described above, the techniques may be implemented by a compiler. In addition to the operations described above, the compiler may perform other compiler operations such as lexical analysis to group the text characters of source code into “tokens”, syntax analysis that groups the tokens into grammatical phrases, semantic analysis that can check for source code errors, intermediate code generation that more abstractly represents the source code, and optimizations to improve the performance of the resulting code. The compiler may compile an object-oriented or procedural language such as a language that can be expressed in a Backus-Naur Form (BNF). Alternately, the techniques may be implemented by other development tools such as an assembler, profiler, or source code pre-processor.

The techniques describe above may be implemented as computer programs coded in a high level procedural or object oriented programming language. However, the program(s) can be implemented in assembly or machine language if desired. The language may be compiled or interpreted.

Other embodiments are within the scope of the following claims.

1. A method, comprising:
registering, in response to an instruction included in source code for an upstream component, a procedure at a downstream component in a packet processing pipeline, the procedure being associated with at least one event;
processing a received packet at the upstream component executing on a first engine; processing the packet at the downstream component executing on a second engine after the processing of the received packet at the upstream component, the processing at the downstream component comprising:
determining occurrence of the at least one associated event at the downstream component; and
in response, executing the registered procedure at the second engine.

2. The method of claim 1, wherein the first engine and second engine comprise engines integrated on the same semiconductor die.

3. The method of claim 2, wherein the first engine and the second engine comprise multi-threaded engines.

4. The method of claim 1, wherein the procedure comprises a procedure that alters data structures defined by the upstream component.

5. The method of claim 1, wherein the upstream component and downstream component comprise one of: adjacent components in the pipeline and non-adjacent components in the pipeline.

6. The method of claim 1, wherein the registering comprises one of: run-time registering and compile-time registering.

7. The method of claim 1, wherein the registering comprises loading instructions for the procedure into the second engine.

8. The method of claim 7, wherein the registering comprises registering the procedure with an event handler that invokes registered procedures in response to events signaled by the downstream component.

9. The method of claim 1, wherein the packet processing pipeline comprises one of the following: an IPv4 packet processing pipeline, an IPv6 packet processing pipeline, and an Asynchronous Transfer Mode (ATM) packet processing pipeline.

10. A computer program, disposed on a computer readable medium, the program comprising instructions to cause a processor to:
access instructions of an upstream component in a packet processing pipeline, the upstream component to be executed by a first engine;
register, in response to an accessed instruction of the upstream component, a procedure at a downstream component in the packet processing pipeline to be executed by a second engine, the procedure to be executed on the second engine in response to the downstream component detecting the occurrence of at least one event.

11. The program of claim 10, wherein the first engine and second engine comprise engines integrated on the same semiconductor die.

12. The program of claim 11, wherein the first engine and the second engine comprise multi-threaded engines.

13. The program of claim 10, wherein the procedure comprises a procedure that alters data structures defined by the upstream component.

14. The program of claim 10, wherein the upstream component and downstream component comprise one of: adjacent components in the pipeline and non-adjacent components in the pipeline.

15. The program of claim 10, wherein the program comprises a compiler.

16. The program of claim 10, wherein the instructions to register comprise instructions to load instructions for the procedure into the second engine.

17. The program of claim 16, wherein the instructions to register comprises instructions to register the procedure with an event handler that invokes registered procedures in response to events signaled by the downstream component.

18. The program of claim 10, wherein the packet processing pipeline comprises one of the following: an IPv4 packet processing pipeline, an IPv6 packet processing pipeline, and an Asynchronous Transfer Mode (ATM) packet processing pipeline.
